(19) United States
(12) Patent Application Publication
(10) Pub. No.: US 2014/0311156 A1
(43) Pub. Date: Oct. 23, 2014

(54) COMBUSTOR CAP FOR DAMPING LOW FREQUENCY DYNAMICS

(71) Applicant: GENERAL ELECTRIC COMPANY, Schenectady, NY (US)

(72) Inventors: Dmitry Vladlenovich Tretyakov, Moscow (RU); Sergey Stryapunn, Moscow (RU); Shiva Srinivasan, Greenville, SC (US)

(73) Assignee: GENERAL ELECTRIC COMPANY, Schenectady, NY (US)

(21) Appl. No.: 14/345,822

(22) PCT Filed: Sep. 22, 2011
(86) PCT No.: PCT/RU2011/000726

§ 371 Date: Mar. 19, 2014

(51) Int. Cl. F23M 23/20; F23R 3/28; F02C 7/24

(52) U.S. Cl. CPC F23M 99/005; F02C 7/24; F23R 3/28
USPC 60/779; 60/725; 60/640

(57) ABSTRACT

A combustor cap for use with a number fuel nozzles, the combustor cap including a cold side plate, a hot side plate, and a cap cavity extending between the cold side plate and the hot side plate with the number of fuel nozzles extending therethrough. A resonator tube may extend from the cold side plate into the cap cavity.

### TECHNICAL FIELD

The present application and the resultant patent relate generally to gas turbine engines and more particularly relate to a combustor for a gas turbine engine with a combustor cap used as a Helmholtz-type resonator for damping low frequency dynamics therein.

### BACKGROUND OF THE INVENTION

Generally described, gas turbine engines combust a mixture of compressed air and compressed fuel to produce hot combustion gases. The hot combustion gases may be used to provide useful mechanical work and drive different types of loads. Combustion may occur in multiple combustors positioned radially around a longitudinal axis of the gas turbine engine. Because of the turbulent nature of the combustion process and the large volumetric energies released in closed cavities, such combustors may be susceptible to a wide range of frequencies and unsteady pressure oscillations of large magnitudes. If one of the combustion frequency bands corresponds to a natural frequency of a part or a subsystem within the gas turbine engine, damage to that part or to the entire engine may result.

Known methods to suppress these pressure oscillations, referred to herein as “dynamics”, traditionally have focused on decoupling the excitation source from the feedback mechanism. Such suppression means generally are effective only over a limited operational range of the combustor. Damping low frequency dynamics is particularly a difficult design issue because a resonator with relatively large dimensions may be needed. Depending upon the location of the resonator, additional cooling also may be needed.

There is thus a desire for improved combustor designs and methods of operations. Preferably, these designs and methods may limit combustor dynamics and the frequency ranges thereof so as to prevent damage to the combustor and insure adequate component lifetime. Damped lower frequency dynamics also should provide overall increased reliability. Moreover, operations closer to an even fuel split between the nozzles of the combustor may be possible without dynamics so as to provide reduced overall emissions of nitrogen oxides and the like.

### SUMMARY OF THE INVENTION

The present application and the resultant patent thus provide a combustor cap for use with a number of fuel nozzles. The combustor cap may include a cold side plate, a hot side plate, and a cap cavity extending between the cold side plate and the hot side plate with the number of fuel nozzles extending therethrough. A resonator tube may extend from the cold side plate into the cap cavity.

The present application and the resultant patent further provide a method of operating a combustor of a gas turbine engine. The method may include the steps of combusting a flow of air and a flow of fuel, producing combustion dynamics, sizing one or more resonator tubes to dampen the combustion dynamics, and positioning the one or more resonator tubes in a cold side plate of a combustor cap.

The present application and the resultant patent further provide a combustor for a gas turbine engine. The combustor may include a number of fuel nozzles, a combustor cap with the fuel nozzles positioned therein, and a number of resonator tubes positioned about a cold side plate of the combustor cap.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine.

FIG. 2 is a side view of a combustor that may be used with the gas turbine engine of FIG. 1.

FIG. 3 is a side cross-sectional view of a combustor cap as may be described herein.

FIG. 4 is a schematic diagram of the combustor cap of FIG. 3 as a Helmholtz resonator.

### DETAILED DESCRIPTION

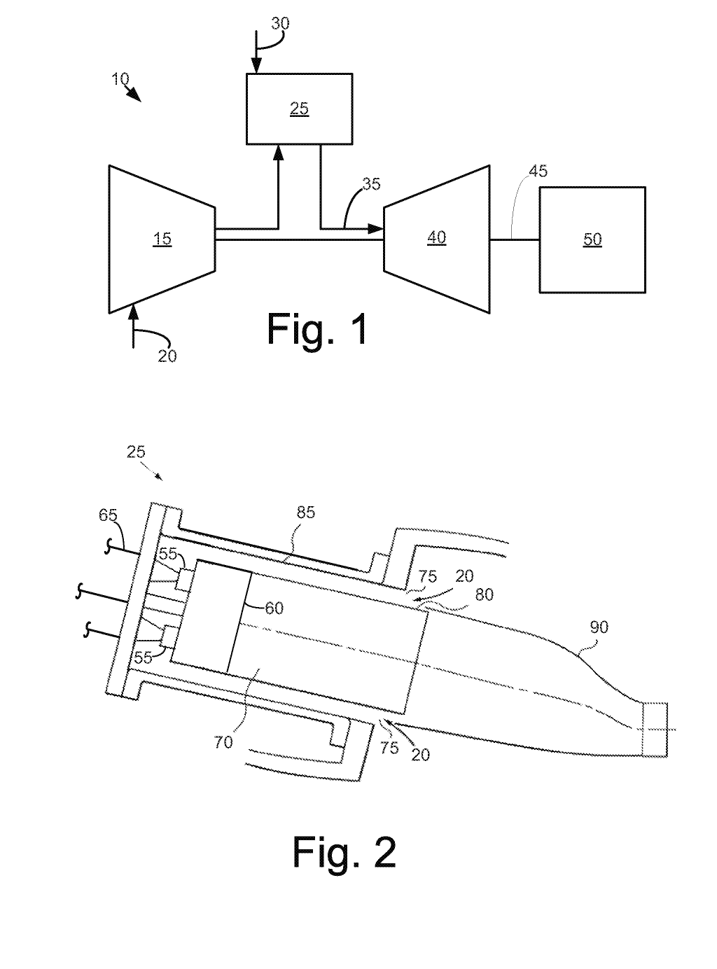

Referring now to the drawings, in which like numerals refer to like elements throughout the several views, FIG. 1 shows a schematic view of a gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, various types of syngas, and/or other types of fuels. The gas turbine engine 10 may be anyone of a number of different gas turbine engines offered by General Electric Company of Schenectady, N.Y. and the like. The gas turbine engine 10 may have different configurations and may use other types of components. Other types of gas turbine engines also may be used herein. Multiple gas turbine engines, other types of turbines, and other types of power generation equipment also may be used herein together.

FIG. 2 shows an example of the combustor 25. In this example, the combustor may be a dry low NOx (DLN) type combustor such as a DLN2.6 combustor offered by General Electric Company of Schenectady, N.Y. Other types of combustors 25 may be used herein. The combustor 25 may include a number of fuel nozzles 55 positioned within a combustor cap 60. In this example, the combustor 25 may include five (5) outer fuel nozzles and a smaller center fuel nozzle. A number of quaternary fuel pegs also may be used. The fuel nozzles 55 may be in communication with the flow of fuel 30 via one or more fuel inlets 65. The combustor cap 60 may have a number of perforations therein for using a portion of the flow of air 20 as a cooling flow. The combustor 25 also may include a combustion chamber 70 with the fuel nozzles 55 at one end thereof. An incoming air path 75 may be defined between a liner 80 of the combustor chamber 70 and a casing 85. A transition piece 90 may be positioned downstream of the combustion chamber 70. Other types of combustor configurations and other components may be used herein.

The flow of air may enter the combustor 25 from the compressor 15 via the incoming air path 75. The flow of air 20 then may reverse direction for mixing with the flow of fuel 30 about the fuel nozzles 55. In the case of gas fuel operation, the flow of air 20 and the flow of fuel 30 mix within the fuel nozzles. In the case of liquid fuel operation, the liquid fuel 30 is supplied directly into the combustion chamber 70. In either case, the mixed flow of air 20 and the flow of fuel 30 may be combusted within the combustion chamber 70. The flow of combustion gases 35 then may be exhausted through the transition piece 90 towards the turbine 40 to produce useful work. The combustor 25 may use a primary fuel that may be a fuel gas; a secondary fuel and a tertiary fuel that may be a premixed fuel gas; and a lean pre-nozzle fuel injection system that may inject the small amount of fuel just upstream of the fuel nozzles 55. Other types of fuel circuits and other combustor configurations may be used herein.

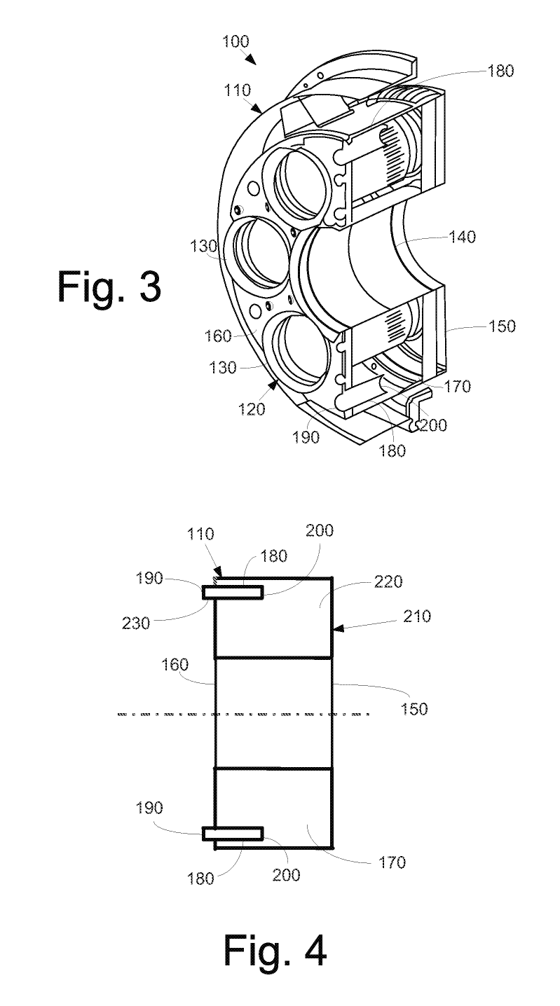

FIG. 3 shows a portion of a combustor 100 as may be described herein. Specifically, the combustor 100 includes a combustor cap 110 with a number of fuel nozzles 120 extending therethrough. As is shown, five (5) outer fuel nozzles 130 and one (1) inner fuel nozzle 140 may be used herein. Any number or configuration of the fuel nozzles 120 may be used herein. The combustor cap 110 also may include a hot side plate 150 facing the combustion chamber 70 and a cold side plate 160 on the opposite side and in communication with the reversed flow of air 20 via the air path 75. A cap cavity 170 may extend between the hot side plate 150 and the cold side plate 160 with the fuel nozzles 120 extending therethrough. Other components and other configurations may be used herein.

The combustor cap 110 also may include a number of resonator tubes 180. Each resonator tube 180 may have an inlet 190 positioned about the cold side plate 160 and an outlet 200 terminating within the cap cavity 170. The resonator tubes 180 may be positioned between each of the outer fuel nozzles 130. As such, five (5) resonator tubes 180 may be used in this example. Any number of resonator tubes 180 may be used herein. Likewise, the size, shape, configuration of each resonator tube 180 may vary. Resonator tubes 180 of varying configurations also may be within the same combustor cap 110. Resonator tubes 180 also may be positioned in other locations about the combustor cap 110. A number of radial baffle plates may be used to divide the cap cavity as desired.

As is shown in FIG. 4, the combustor cap 110 thus acts as a Helmholtz resonator 210. The Helmholtz resonator 210 includes the cap cavity 170 acting as a body 220 and the resonator tubes 180 acting as a throat 230. Generally defined, the Helmholtz resonator 210 is an acoustical chamber that induces a pressurized fluid to oscillate at a particular frequency. The geometric configuration of the Helmholtz resonator 210 directly determines the frequency of oscillation. If the fluid pressure is fluctuating due to the influence of an external force, the resonator 210 may dampen the magnitude of the fluctuations if tuned to the frequency of those fluctuations. The Helmholtz resonator 210 thus includes the body 220 and the throat 230 with a smaller diameter than the body 220. Pressurized fluid entering the throat 230 is collected in the body 220 until the pressure within the body 220 becomes greater than the external fluid pressure. At that point, the fluid within the body 220 exits via the throat 230, thereby reducing the pressure within the body 220. The lower body pressure induces the fluid to re-enter the body 220, such that the process repeats. The cyclical movement of air establishes a resonant frequency of the Helmholtz resonator 210.

As above, the resonate frequency of the Helmholtz resonator 210 is determined mainly by its geometric configuration. Specifically, a cylindrical Helmholtz resonator 210 produces a resonant frequency “f” based in part upon the following equation: f=c/2Π*√d²/LHD². In this equation, “c” is the speed of sound through the fluid (e.g., air, fuel, diluent, etc.), “d” is the diameter of the throat 230, “L” is the length of the throat 230, “H” is the length of the body 220, and “D” is the diameter of the body 220. In this example, the configuration of the body 220, i.e., the cap cavity 170, is fixed such that the resonant frequency may be varied by varying the length and diameter of the throat 230, i.e., the resonator tubes 180. As such, the resonator tubes 180 may be sized to dampen certain frequency ranges such as those most severe for the combustion hardware. Any number of resonator tubes 180 may be used herein in any desired size, shape, or configuration. Resonator tubes 180 of different configurations also may be used herein together so as to dampen different frequency ranges. The resonator tubes 180 used herein thus may be designed so as to dampen lower frequency ranges although any frequency or range of frequencies may be targeted herein. For example, a resonator 210 with a natural frequency range of about 170 Hz may be used for damping oscillations from about 80 to about 400 Hz.

The positioning of the Helmholtz resonator 210 about the cold side plate 160 may be more effective than positioning about the hot side plate 150. Specifically, the flow of air 20 about the cold side plate 160 may have a higher density and a lower sound speed as compared to the hot side plate 150 facing the combustion chamber 70. Moreover, positioning the Helmholtz resonator 210 about the cold side plate 160 does not require any further and/or different cooling schemes. Rather, the configuration of the existing combustor cap 110 may be used herein. The resonator tubes 180 may be welded onto the cold side plate 160 and/or otherwise attached. Combustion operations closer to an even fuel split may be used herein with reduced dynamics so as to provide overall lower emissions of nitrogen oxides and the like.

The resonator tubes 180 also may provide the flow of air 20 into the cap cavity 170 so as to provide cooling to the hot side plate 150. The diameter of the resonator tubes 180 thus may be varied according to the desired cooling flow. The resonator tubes 180 thus may be more effective in providing cooling as compared to the use of small perforations therein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A combustor cap for use with a number of fuel nozzles, comprising:
a cold side plate;
a hot side plate;
a cap cavity extending between the cold side plate and the hot side plate with the number of fuel nozzles extending therethrough; and
a resonator tube extending from the cold side plate into the cap cavity.

2. The combustor cap of claim 1, wherein the resonator tube comprises an inlet positioned about the cold side plate and an outlet positioned within the cap cavity.

3. The combustor cap of claim 1, further comprising a plurality of resonator tubes.

4. The combustor cap of claim 3, wherein the number of fuel nozzles comprises a number of outer fuel nozzles with the number of outer fuel nozzles comprising a first number and wherein the plurality of resonator tubes comprises a number of resonator tubes of the first number.

5. The combustor cap of claim 4, wherein one of the number of resonator tubes is positioned between a pair of the number of outer fuel nozzles.

6. The combustor cap of claim 3, wherein the number of fuel nozzles comprises a number of outer fuel nozzles with the number of outer fuel nozzles being five (5) and wherein the plurality of resonator tubes comprises five (5) resonator tubes.

7. The combustor cap of claim 3, wherein the plurality of resonator tubes comprises a plurality of differently sized resonator tubes.

8. The combustor cap of claim 1, wherein the cap cavity and the resonator tube comprise a Helmholtz resonator.

9. The combustor cap of claim 8, wherein the cap cavity comprises a body of the Helmholtz resonator.

10. The combustor cap of claim 8, wherein the resonator tube comprises a throat of the Helmholtz resonator.

11. The combustor cap of claim 8, wherein the Helmholtz resonator dampens oscillations therethrough.

12. The combustor cap of claim 8, further comprising a plurality of resonator tubes and wherein each of the plurality of resonator tubes comprises a predetermined length and a predetermined diameter.

13. The combustor cap of claim 12, wherein the predetermined length and the predetermined diameter correspond to a combustion frequency.

14. The combustor cap of claim 8, further comprising a plurality of Helmholtz resonators.

15. A method of operating a combustor of a gas turbine engine, comprising:
combusting a flow of air and a flow of fuel;
producing combustion dynamics;
sizing one or more resonator tubes to dampen the combustion dynamics; and
positioning the one or more resonator tubes in a cold side plate of a combustor cap.

16. A combustor for a gas turbine engine, comprising:
a plurality of fuel nozzles;
a combustor cap with the plurality of fuel nozzles positioned therein; and
a plurality of resonator tubes positioned about a cold side plate of the combustor cap.

17. The combustor of claim 16, wherein the plurality of resonator tubes comprises a plurality of differently sized resonator tubes.

18. The combustor of claim 16, wherein the plurality of resonator tubes extends from the cold side plate into a cap cavity of the combustor cap.

19. The combustor of claim 18, wherein the cap cavity and the plurality of resonator tubes comprise a Helmholtz resonator to dampen oscillations therethrough.

20. The combustor of claim 19, wherein the plurality of resonator tubes comprises a throat of the Helmholtz resonator.
